(19) United States
(12) Patent Application Publication
(10) Pub. No.: US 2016/0201702 A1
(43) Pub. Date: Jul. 14, 2016

(54) DAMAGE FREE WAY TO ATTACH A PICK-UP TRUCK CAP TO THE PICK-UP BED

(71) Applicant: GM Global Technology Operations LLC, Detroit, MI (US)

(72) Inventor: RICHARD L. JOHNSON, Dryden, MI (US)

(21) Appl. No.: 14/596,803

(22) Filed: Jan. 14, 2015

(51) Int. Cl. F16B 5/00

(52) U.S. Cl. CPC F16B 5/0096

(57) ABSTRACT

A product and method are disclosed for securing a structure to a pickup truck in a damage-free way. The pickup may have a bed rail with a stake pocket having walls. An anchor having an expandable section with a bolt extending through the expandable section may be positioned into the stake pocket. A structure having a mounting flange with a hole in the mounting flange may be positioned onto the bed rail so that the bolt extends through the hole. A fastener may be applied to the bolt and tightened to compress the expandable section and simultaneously clamp the mounting flange to the bed rail. By forcing the expandable section against the walls of the stake pocket, the structure may be secured on the bed rail.

### TECHNICAL FIELD

The field to which the following disclosure generally relates includes pickup trucks and more particularly, may include pickup trucks with bed caps or other structures attached over the pickup's bed.

### BACKGROUND

Many pickup truck owners attach covers, caps, campers, protective liners, or other structures over the pickup's bed for a variety of purposes. The typical manner of attaching such a structure includes drilling through the bed rail and extending bolts through the resulting holes and through aligning holes in the structure. This provides a suitable method of securing the structure to the pickup, but results in rough holes through the pickup rails that may become undesirable if the structure is removed.

Another method of attaching a structure over a pickup's bed involves the use of clamps. The damps secure the structure to the bed rail and avoid the need to drill holes. However, clamps do not provide direct interference against relative sliding between the bed rail and the structure but instead rely on friction and the pressure applied by the clamp. As a result, the damps may effect localized denting where they apply pressure to the bed rails. These localized dents may also become undesirable if the structure is removed from the bed.

### SUMMARY OF ILLUSTRATIVE VARIATIONS

A number of variations as described herein may include a product and a method for securing a structure to a pickup truck in a damage-free way. The pickup may have a bed rail with a stake pocket that has walls. An anchor may have an expandable section, with a fastener extending through the expandable section. The anchor may be positioned into the stake pocket. A structure having a mounting flange with a hole in the mounting flange may be positioned onto the bed rail so that the fastener extends through the hole. The fastener may be secured to compress the expandable section and simultaneously clamp the mounting flange to the bed rail. The structure may be secured on the bed rail by forcing the expandable section against the walls of the stake pocket and capturing the mounting flange against the bed rail with the fastener.

According to a number of other variations described herein a method may include the steps of providing a pickup truck having a bed rail that has a stake pocket with walls. The stake pocket may provide an opening through the bed rail. An anchor assembly may be provided that may be configured to secure a structure to the bed rail. The anchor assembly may have an elastic element that may have an opening. A bolt with threads may be positioned through the opening so that the threads extend out of the elastic element. The anchor assembly may be positioned in the stake pocket so that the threads extend out of the stake pocket. The structure may be positioned onto the bed rail so that the bolt extends through an opening in the structure. A fastener may be applied to the bolt threads and tightened, expanding the elastic element against the walls of the stake pocket and securing structure to the bed rail.

In a number of other variations described herein a product may be defined for securing a structure to a pickup bed. A bed rail may have a stake pocket with walls. The stake pocket may present an opening through the bed rail. An anchor assembly may be positioned in the stake pocket and may be configured to secure the structure to the bed rail. The anchor assembly may have an elastic element that defines an opening. A bolt may be disposed within and may extend through the opening so that the bolt extends out of the elastic element and the stake pocket. The structure may be positioned on the bed rail so that the bolt extends through a hole in the structure. A fastener may be coupled with the bolt. The elastic element may be compressed by the bolt and expanded against the walls of the stake pocket, securing the structure to the bed rail.

Other illustrative variations within the scope of the invention will become apparent from the illustration and the detailed description provided herein. It should be understood that the illustration, the detailed description and any specific examples, while disclosing variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawing, wherein:

The FIGURE is a schematic cross sectional illustration of part of a vehicle's bed rail with an anchoring structure according to a number of variations.

### DETAILED DESCRIPTION OF ILLUSTRATIVE VARIATIONS

The following description of the variations is merely illustrative in nature and is in no way intended to limit the scope of the invention, its application, or uses.

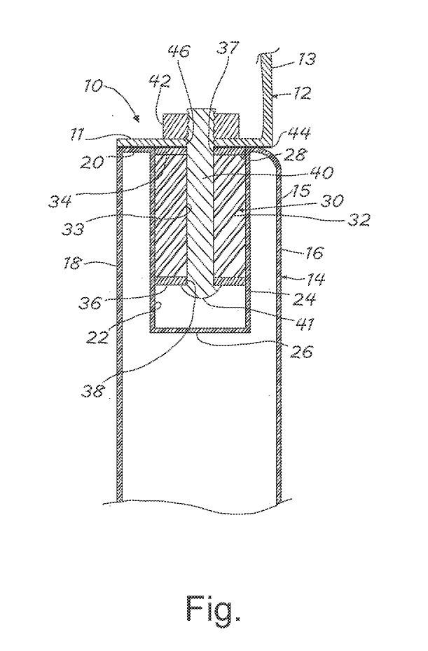

The use of pickup trucks may include a number of purpose built structures that are placed over the bed of the pickup. The structure may be a cap with a low profile that provides a means of securing the contents of the bed, or may be a cap that has a height about the height of the cab of the pickup, or may be a camper that extends above the height of the cab, or may be yet another structure that secures articles or protects the bed from wear or from the weather. For some structures, rather than extending upward, the structure may extend over the bed rail and downward into the bed of the pickup. For the variety of structures, there exists a need to secure the structure to the pickup. According to a number of variations, FIG. 1 illustrates a product 10 for securing a structure 12 to a pickup box 14. The structure 12 may include a mounting flange 11 and a vertical wall 13. As opposed to extending upward from the outboard side of the box, the wall may extend downward from the inboard side of the box, or as otherwise needed for the purpose of the selected structure.

The box 14 may include an outer wall 15 with an outward facing styling surface 16, and an inner box wall 18. A bed rail 20 may be formed between the outer wall 15 and the box wall 18 presenting a relatively flat horizontal surface that extends along the sides of the pickup's box. The bed rail 20 may be provided with a number of stake pockets 22. Stake pockets may be provided for inserting the stakes of a stake and rail structure for accommodating loads that are taller than the pickup bed itself. The stake pocket 22 may have four side walls 24 and a bottom 26, and may exhibit an opening 28 that presents itself through the bed rail 20.

An anchor assembly 30 may be inserted into the stake pocket 22 and may include an elastic element 32, able to resume its normal shape spontaneously after distortion. The elastic element 32 may be sized to closely fit within the walls 24 of the stake pocket 22 so that friction will hold it in a vertical position against its own weight when inserted. The elastic element 32 may also have a longitudinal opening 33 that extends completely through its body, and at least a section of the elastic element 32 may be expandable. Anchor assembly 30 may include an upper compression plate 34 and a lower compression plate 36, each being rigid and sized to fit within the stake pocket 22 with clearance, and each having a central hole 37, 38. A bolt 40 may have an enlarged head 41 or may be otherwise engaged with the lower compression plate 36. The bolt 40 may extend through the hole 38 of lower compression plate 36, the longitudinal opening 33 of elastic element 32, and the hole 37 of the upper compression plate 34. A fastener in the form of a nut 42 may be attached to the bolt 40. By tightening the nut 42, the compression plates 34, 36 are forced toward one another compressing the elastic element 32. As elastic element 32 is compressed it may be urged to expand laterally, pressing against the walls 24 of the stake pocket 22, securing the anchor assembly 30 in place.

To secure the structure 12 on the pickup box 14 the anchor assembly 30 may be inserted into the stake pocket 22 with the threaded end of bolt 40 extending upward above the bed rail 20. The anchor assembly 30 may be inserted so that the upper compression plate 34 is approximately level with the bed rail 20 and then the nut 42 may be removed. Optionally, prior to insertion of the anchor assembly 30, a resilient plate 44 having an aperture or opening that has a diameter smaller than the diameter of the bolt 40 may be applied over the bolt 40 on top of, and adjacent to, the upper compression plate 34. The resilient plate 44 may provide protection for the upper surface of the bed rail 20 and may help hold the anchor assembly 30 and/or bolt 40 in its vertical position in the stake pocket 22 during positioning of the structure 12.

The mounting flange 11 of the structure 12 may be provided with a number of sized holes or openings 46 corresponding to the number of anchors to be used. Once the anchors are in position in the stake pockets and the nuts are removed, the structure 12 may be positioned and lowered into place with the bolt 40 extending through the opening 46. Once in position, the nut may be placed back on the bolt 40 and tightened. As nut 42 is attached and tightened, lower compression plate 36 is pulled toward upper compression plate 34 compressing the elastic element 32 in the vertical direction and forcing it to expand in the lateral directions. This forces the elastic element 32 against the walls 24 of the stake pocket 22 and secures the structure 12 to the pickup box 14. Since the bolt 40 extends through the opening 46 in mounting flange 11, the bolt 40 directly interferes with lateral movement of the structure 12 relative to the bed rail 20. The potential for movement may be minimized by providing minimal clearance between the opening 46 and the bolt 40 where the diameter of the opening is only slightly larger than the diameter of the bolt.

Through the foregoing variations, a product and method is provided for a damage free way to attach a pick-up truck cap or other structure to the pickup's bed. The preceding description and the following description of variants is only illustrative of components, elements, acts, products and methods considered to be within the scope of the invention and is not in any way intended to limit such scope by what is specifically disclosed or not expressly set forth. Components, elements, acts, products and methods may be combined and rearranged other than as expressly described herein and still are considered to be within the scope of the invention.

Variation 1 may include a method for securing a structure to a pickup truck. The pickup may have a bed rail with a stake pocket having walls. An anchor having an expandable section with a fastener extending through the expandable section may be positioned into the stake pocket. A structure having a mounting flange with a hole in the mounting flange may be positioned onto the bed rail so that the fastener extends through the hole. The fastener may be secured to compress the expandable section and simultaneously clamp the mounting flange to the bed rail. The structure may be secured on the bed rail by forcing the expandable section against the walls of the stake pocket and capturing the mounting flange against the bed rail with the fastener.

Variation 2 may include a method according to variation 1 and may include the step of preventing the structure from moving laterally by providing a diameter of the hole that is only slightly larger than a diameter of the fastener.

Variation 3 may include a method according to variation 1 or 2 and may include the step of providing a thin resilient plate with an opening. The plate may be positioned between the bed rail and the mounting flange with the fastener extending through the opening, before the structure is positioned onto the bed rail

Variation 4 may include a method according to variations 3 and may include the step of preventing the fastener from dropping to a bottom of the stake pocket by providing a diameter of the opening that is slightly smaller than then a diameter of the fastener.

Variation 5 may include a method that may include the steps of providing a pickup truck having a bed rail that has a stake pocket with walls. The stake pocket may provide an opening through the bed rail. An anchor assembly may be provided that may be configured to secure a structure to the bed rail. The anchor assembly may have an elastic element that may have an opening. A bolt with threads may be positioned through the opening so that the threads extend out of the elastic element. The anchor assembly may be positioned in the stake pocket so that the threads extend out of the stake pocket. The structure may be positioned onto the bed rail so that the bolt extends through an opening in the structure. A fastener may be applied to the bolt threads and tightened expanding the elastic element against the walls of the stake pocket and securing structure to the bed rail.

Variation 6 may include a product for securing a structure to a pickup bed. A bed rail may have a stake pocket with walls. The stake pocket may present an opening through the bed rail. An anchor assembly may be positioned in the stake pocket and may be configured to secure the structure to the bed rail. The anchor assembly may have an elastic element that defines an opening. A bolt may be disposed within and may extend through the opening so that the bolt extends out of the elastic element and the stake pocket. The structure may be positioned on the bed rail so that the bolt extends through a hole in the structure. A fastener may be coupled with the bolt. The elastic element may be compressed by the bolt and expanded against the walls of the stake pocket, securing the structure to the bed rail.

Variation 7 may include a product according to variation 6 and may include a rigid compression plate positioned on each opposite end of the elastic element with the bolt extending through both compression plates

Variation 8 may include a product according to variation 6 or 7 and may include a resilient plate positioned between the bed rail and the structure. The resilient plate may have an aperture through which the bolt extends. A diameter of the aperture may be smaller than a diameter of the bolt.

Variation 9 may include a product according to variation 7 or 8 wherein both compression plates fit within the stake pocket.

Variation 10 may include a product according to any of variations 6 through 9 wherein the structure may be a pickup box cap.

The above description of select variations within the scope of the invention is merely illustrative in nature and, thus, variations or variants thereof are not to be regarded as a departure from the spirit and scope of the invention.

What is claimed is:

1. A method for securing a structure to a pickup truck bed rail having a stake pocket with walls, including the steps of:
a. positioning an anchor having an expandable section, with a fastener extending through the expandable section, into the stake pocket;
b. positioning a structure having a mounting flange, with a hole in the mounting flange, onto the bed rail so that the fastener extends through the hole;
c. securing the fastener to compress the expandable section and simultaneously clamp the mounting flange to the bed rail; and
d. securing the structure on the bed rail by forcing the expandable section against the walls of the stake pocket and capturing the mounting flange against the bed rail with the fastener.

2. The method according to claim 1 including the step of preventing the structure from moving laterally by providing a first diameter of the hole that is only slightly larger than a second diameter of the fastener.

3. The method according to claim 1 including the step of providing a resilient plate with an opening; positioning the resilient plate between the bed rail and the mounting flange before the structure is positioned onto the bed rail; and extending the fastener through the opening.

4. The method according to claim 3 including the step of preventing the fastener from dropping to a bottom of the stake pocket by providing the opening with a first diameter, wherein the first diameter is smaller than then a second diameter of the fastener.

5. A method including the steps of:
a. providing a pickup truck bed rail with a stake pocket having walls, the stake pocket presenting an opening through the bed rail;
b. providing an anchor assembly configured to secure a structure to the bed rail, the anchor assembly having an elastic element, with an opening in the elastic element;
c. positioning a bolt with threads through the opening so that the threads extend out of the elastic element;
d. positioning the anchor assembly in the stake pocket so that the threads extend out of the stake pocket;
e. positioning a structure onto the bed rail so that the bolt extends through a hole in the structure;
f. applying a fastener to the bolt threads and tightening the fastener; and,
g. expanding the elastic element against the walls of the stake pocket, securing structure to the bed rail.

6. A product for securing a structure to a pickup bed comprising: a bed rail having a stake pocket with walls, the stake pocket presenting an opening through the bed rail; an anchor assembly positioned in the stake pocket and configured to secure the structure to the bed rail, the anchor assembly having an elastic element that defines an opening; a bolt disposed within and extending through the opening so that the bolt extends out of the elastic element and the stake pocket; wherein the structure is positioned on the bed rail so that the bolt extends through a hole in the structure; and a fastener coupled with the bolt, and wherein the elastic element is compressed by the bolt and expanded against the walls of the stake pocket, securing the structure to the bed rail.

7. The product according to claim 6 further comprising a pair of rigid compression plates positioned on opposite ends of the elastic element, the bolt extending through each of the pair of rigid compression plates.

8. The product according to claim 6 further comprising a resilient plate positioned between the bed rail and the structure wherein the resilient plate has an aperture through which the bolt extends and wherein a first diameter of the aperture is smaller than a second diameter of the bolt.

9. The product according to claim 7 wherein each of the pair of rigid compression plates fits within the stake pocket.

10. The product according to claim 6 wherein the structure is a pickup box cap.
